(19) United States
(12) Patent Application Publication
(10) Pub. No.: US 2012/0140491 A1
(43) Pub. Date: Jun. 7, 2012

(54) LED LAMP

(75) Inventor: PING-JUNG TSAI, Chu-Nan (TW)

(73) Assignee: FOXSEMICON INTEGRATED TECHNOLOGY, INC., Chu-Nan (TW)

(21) Appl. No.: 13/300,625

(22) Filed: Nov. 20, 2011

(30) Foreign Application Priority Data
Dec. 1, 2010 (TW) 099141661

(51) Int. Cl. F21V 15/01

(52) U.S. Cl. 362/375

(57) ABSTRACT

An LED (light emitting diode) lamp includes two lamp modules. Each lamp module includes a housing, an LED module received in the housing, a sleeve received in the housing and enclosing the LED module, a cover fixed to the housing to cover the LED module and a plug inserted into the cover. The housing includes a plate and a sidewall extending from the plate. The two plates of the two lamp modules are connected to each other. The two lamp modules are oriented towards upwardly and downwardly, respectively. Light produced from the two lamp modules illuminates areas above, below and surrounding the LED lamp.

### BACKGROUND

1. Technical Field

The present disclosure relates to LED (light emitting diode) lamps, and more particularly, to an LED lamp incorporating a plurality of lamp modules.

2. Description of Related Art

Light emitting diodes (“LEDs”) are widely used as new types of light sources in various applications such as road lamps, traffic lamps, tunnel lamps, resident lamps and so on. A typical LED lamp often includes a housing, a plurality of LEDs mounted within the housing and a cover fixed to the housing to cover the LEDs. The LEDs emit light to the outside environment through the cover to thereby illuminate predetermined areas. However, the light output from the typical LED lamp can only illuminate the areas surrounding the LED lamp. The areas below or above the LED lamp cannot obtain sufficient illumination.

What is needed, therefore, is an LED lamp which may overcome the deficiencies as described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and assembled view of an LED lamp in accordance with an embodiment of the present disclosure.

FIG. 2 is an exploded view of the LED lamp of FIG. 1.

FIG. 3 shows an LED lamp in accordance with another embodiment of the present disclosure.

FIG. 4 shows a bracket of the LED lamp of FIG. 3.

### DETAILED DESCRIPTION OF THE EMBODIMENTS

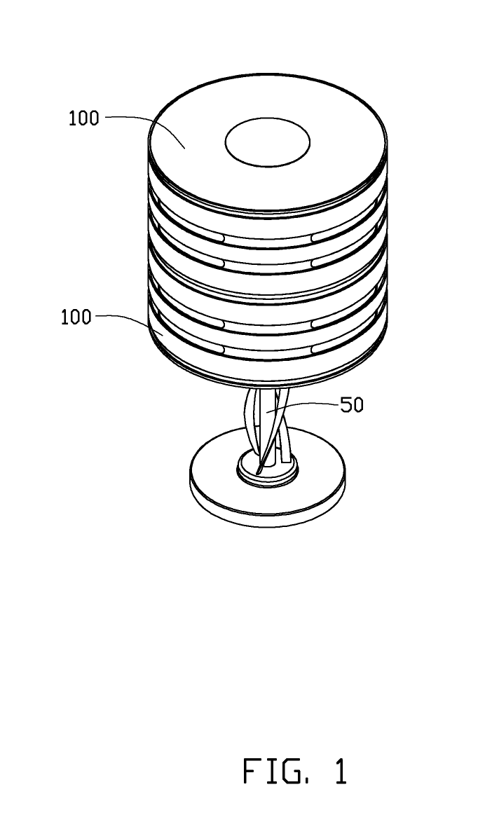

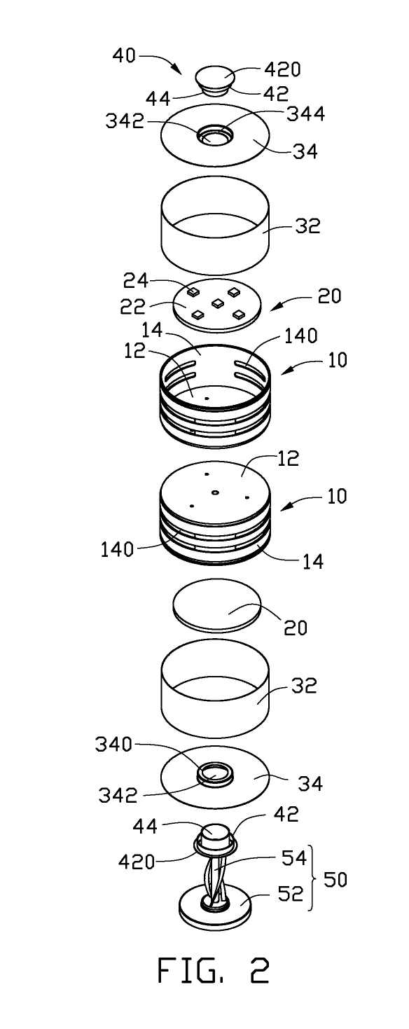

Referring to FIGS. 1-2, an LED (light emitting diode) lamp in accordance with an embodiment of the present disclosure is shown. The LED lamp includes a pair of lamp modules 100 connected to each other and a bracket 50 supporting the pair of lamp modules 100.

The two lamp modules 100 have the same configurations. Each lamp module 100 includes a housing 10, a lampshade 32 received in the housing 10, an LED module 20 mounted in the housing 10 and a cover 34 fixed on the housing 10. The housing 10 includes a circular plate 12 and a sidewall 14 extending perpendicularly out from a periphery of the plate 12. The sidewall 14 defines a plurality of elongated photic openings 140 therein. The photic openings 140 extend along a circumferential direction of the sidewall 14 of the housing 10.

The lampshade 32 may be made of transparent materials such as glass, epoxy or silicon. Alternatively, the lampshade 32 may further have a predetermined color for generating different illumination effects. The lampshade 32 is a hollow sleeve having a diameter equal to or slightly less than an inner diameter of the sidewall 14 of the housing 10. Thus, the lampshade 32 is received in the housing 10 to cover the openings 140.

The LED module 20 includes a printed circuit board 22 and a plurality of LEDs 24 mounted on the printed circuit board 22. The printed circuit board 22 of the LED module 20 is fixed onto the plate 12 of the housing 10. The LEDs 24 are enclosed by the lampshade 32 to emit light through the lampshade 32 and the photic openings 140 of the housing 10 to an outside environment.

The cover 34 is fixed to an end of the sidewall 14 away from the plate 12, and covers the housing 10. The cover 34 may also be made of light-transmittable material like the lampshade 32, whereby the light emitting from the LEDs 24 can also radiate to the outside environment through the cover 34. The cover 34 forms a depression 344 extending downwardly towards the LEDs 24. A through hole 342 is defined in a bottom of the depression 344. The depression 344 forms an annulus 340 surrounding and adjacent to the through hole 342. The annulus 340 is located lower than other portions of the cover 34 surrounding the depression 344.

The two lamp modules 100 are fixed to each other in a back-to-back manner that the two plates 12 of the two lamp modules 100 abut against each other by fasteners (not shown) such as bolts extending through the tow plates 12. The two sidewalls 14 of the two lamp modules 100 are located at two opposite sides of the two plates 12, the two covers 34 are located at two opposite ends of the two sidewalls 14. When the LED modules 20 work, light emitting by the LED modules 20 radiates out of the LED lamp via the photic openings 140 and the covers 34. Therefore, the two lamp modules 100 are oriented upwardly and downwardly to illuminate areas above and below the LED lamp, respectively. Furthermore, the light radiated from the openings 140 through the lampshades 32 illuminates areas surrounding the LED lamp. Thus, the LED lamp can achieve 360 degrees illumination.

A plug 40 is fixed to the cover 34 of the each lamp module 100 to seal the depression 344 of the cover 34. The plug 40 includes a base 420, an annular wall 42 and a sleeve 44 extending from the base 420. The annular wall 42 surrounds the sleeve 44 and has a height less than that of the sleeve 44. The base 420 is circular and has a diameter similar to that of the depression 344 of the cover 34. The plug 40 is inserted to the depression 344 in a manner that the annular wall 42 abuts against the annulus 340, the base 420 covers the depression 344 and is coplanar with the other portions of the cover 34 surrounding the depression 344, and the sleeve 44 extends through the through hole 342 into an interior of the housing 10.

The bracket 50 includes a chassis 52 and a pole 54 interconnecting the plug 40 of the lower lamp module 100 and the chassis 52. The chassis 52 may be disposed on a flat surface such as a desk or floor for supporting the lower lamp module 100. The bracket 50 can further include a plurality of twisting supports (not labeled) around the pole 54 and interconnecting the plug 40 and the chassis 52 to provide much support to the lamp modules 100 and advance aesthetic appearance of the LED lamp.

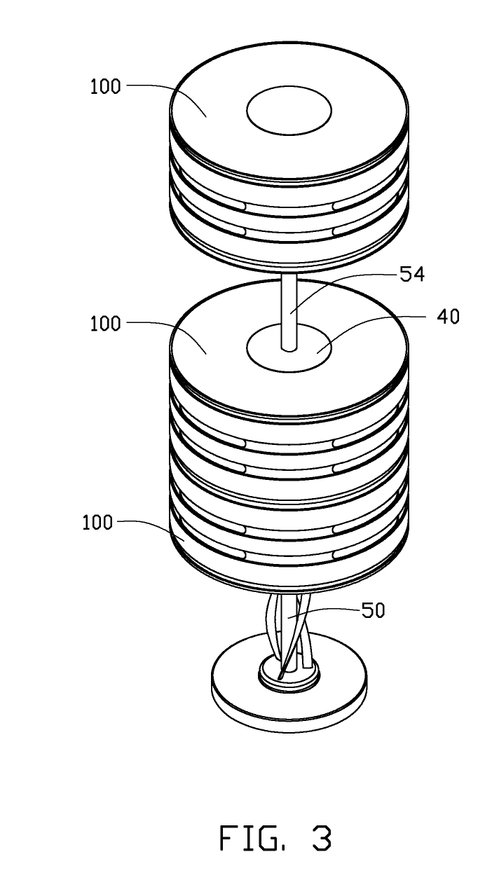

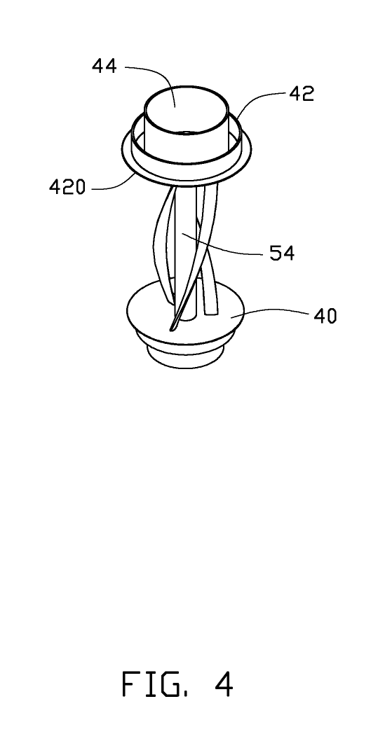

If the LED lamp is used in an environment requiring low illumination, the upper lamp module 100 may be removed and only the lower lamp module 100 is retained. The light produced by the lower lamp module 100 can satisfy the low illumination requirement. If the lamp is used in another environment requiring high illumination, the upper lamp module 100 is assembled with the lower lamp module 100 to cooperatively produce more light. Furthermore, if higher illumination is required, a third lamp module 100 can be further assembled to the upper lamp module 100 by another type of bracket which includes two opposite plugs 40 and a pole 54 interconnecting the two plugs 40 as shown in FIGS. 3-4. A fourth lamp module 100 can be further assembled to the third lamp module 100 like the upper lamp module 100 if the illumination is still insufficient.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED (light emitting diode) lamp comprising:
two lamp modules stacked together, the two lamp modules each comprising:
a housing comprising a plate and an annular sidewall extending from a periphery of the plate; the sidewall defining a plurality of photic openings extending along a circumferential direction of the sidewall;
an LED module received in the housing; and
a cover engaging with one end of the sidewall and enveloping the LED module in the housing;
wherein the two plates of the two lamp modules abut against each other, the two sidewalls of the two lamp modules are located at two opposite sides of the two plates, the two covers are located at two opposite ends of the two sidewalls, and when the LED modules work, light emitting by the LED modules radiates out of the LED lamp via the photic openings and the covers.

2. The LED lamp of claim 1 further comprising a lampshade received in the housing of each lamp module, wherein the lampshade covers the photic openings of the housing.

3. The LED lamp of claim 1, wherein the cover of each lamp module defines a depression therein, and a plug is inserted in the depression of the cover.

4. The LED lamp of claim 3, wherein the plug comprises a base and an annular wall extending from the base towards the LED module, the base and the annular wall being received in the depression.

5. The LED lamp of claim 4, wherein the plug further comprises a sleeve extending from the base towards the LED module, the sleeve being surrounded by the annular wall and having a height more than that of the annular wall.

6. The LED lamp of claim 5, wherein the depression defines a through hole in a bottom thereof, the depression forming an annulus surrounding and adjacent to the through hole.

7. The LED lamp of claim 6, wherein the annular wall of the plug abuts against the annulus, and the sleeve extends through the through hole.

8. The LED lamp of claim 2, wherein the lampshade is transparent.

9. The LED lamp of claim 1, wherein the two lamp modules are oriented towards an upward direction and a downward direction, respectively.

10. The LED lamp of claim 3, wherein a chassis is connected to the plug of one lamp module through a pole.

11. The LED lamp of claim 3, wherein the two lamps are connected by fixing the two plugs through a pole.

12. An LED (light emitting diode) lamp comprising:
a housing comprising a plate and an annular sidewall extending from a periphery of the plate; the sidewall defining a plurality of photic openings extending along a circumferential direction of the sidewall;
an LED module received in the housing; and
a cover engaging with one end of the sidewall and enveloping the LED module in the housing;
wherein when the LED module works, light emitting by the LED module radiates out of the LED lamp via the photic openings and the cover.

13. The LED lamp of claim 12, wherein the cover defines a depression therein, the plug being received in the depression.

14. The LED lamp of claim 13, wherein the cover defines a through hole in a bottom of the depression, a circumferential part of the bottom of the depression surrounding and adjacent to the through hole forming an annulus.

15. The LED lamp of claim 14, wherein the plug comprises a base, a sleeve and an annular wall extending from the base towards the LED module, the sleeve extending through the through hole and the annular wall abutting against the annulus.

16. The LED lamp of claim 15, wherein the sleeve is surrounded by the annular wall and has a height larger than that of the annular wall.

17. The LED lamp of claim 1 further comprising a lampshade received in the housing and enclosing the LED module, and the lampshade overlays the photic openings.
